(19) United States
(12) Patent Application Publication
(10) Pub. No.: US 2009/0278662 A1
(43) Pub. Date: Nov. 12, 2009

(54) System and method for determining the position of instrumented biological agents

(76) Inventors: Hernando A. Sanchez, Boston, MA (US); James Rooney, III, Harvard, MA (US)

Correspondence Address: Iandiorio Teska & Coleman, 260 Bear Hill Road, Waltham, MA, 02451, US

(21) Appl. No.: 12/384,316

(22) Filed: Apr. 2, 2009

Related U.S. Application Data
(60) Provisional application No. 61/072,828, filed on Apr. 2, 2008.

(51) Int. Cl. H04Q 5/22; G01S 3/02; G08B 5/22

(52) U.S. Cl. 340/10.1; 342/463; 340/825.49

(57) ABSTRACT

A system for determining the position of instrumented biological agents including a plurality of biological agents each having a miniature transmitter/receiver attached thereto. A plurality of antenna is placed about an area of interest. An interrogator subsystem is configured to determine the position of each miniature transmitter/receiver on each of the plurality of biological agents in the area of interest.

### RELATED APPLICATION

This application hereby claims the benefit of and priority to U.S. Provisional Application Ser. No. 61/072,828, filed on Apr. 2, 2008 under 35 U.S.C. §§119, 120, 363, 365, and 37 C.F.R. §1.55 and §1.78, incorporated by reference herein.

### FIELD OF THE INVENTION

This invention relates to a system and method for determining the position and/or movement of instrumented biological agents and, in one embodiment, a system and method for detecting a substance using instrumented and conditioned biological agents.

### BACKGROUND OF THE INVENTION

Insects, such as bees, wasps, moths, aphids, and the like, often referred to as “biological agents”, can be conditioned to detect odors and/or vapors associated with various substances, such as explosives, tobacco, drugs, chemicals, and the like, to a levels as low as parts per trillion and 10-18 molar. See, e.g., U.S. Pat. Nos. 6,896,579, 6,919,202, and 7,237,504, all of which are incorporated by reference herein. Extensive research has also been conducted which successfully shows the conditioning of honey bees to detect chemicals at levels as low as parts per quadrillion. See e.g., “The Training and Deployment of Honey Bees To Detect Explosive and Other Agents of Harm”, by Rodacy et al., Proceedings of SPIE, Vol. 4742 (2002), incorporated by reference herein. Such detection by biological agents is orders of magnitude more sensitive than man-made sensors.

Some known methods which use bees to detect chemicals associated with explosive devices, such as an improvised explosive device (IED), landmines, and the like, utilize light detection and ranging (LIDAR) and radio detecting and ranging (RADAR). These methods typically require a visual line-of-sight to the population of bees in order to detect the location of the swarms of bees which may indicate a target or explosive substance has been located. Methods using RADAR may also rely on attaching an antenna to the bees in order to increase their RADAR reflecting capabilities.

For example, one conventional method of tracking the position of honey bees in flight utilizes LIDAR to monitor honey bee location and dwell time. See e.g., “Polarization Lidar Measurements of Honey Bees in Flight For Locating Land Mines”, by Shaw et al., Optics Express 5853, Vol. 13, No. 15 (25 Jul. 2005) and U.S. Pat. No. 7,148,984, all of which are incorporated by reference herein. In one LIDAR method, an active mine field and an adjacent mine-free control region was utilized. The mine field was scanned using chemical detectors to identify plumes of TNT and 2,4-DNT. Honey bees previously trained to detect TNT and 2,4-DNT were allowed to forage over a mine field while a LIDAR system scanned the airspace over the mine field to detect relative honey bee density. Visual and video cameras were also used to count honey bees. The mine field was relatively flat, but did have a high spot in the middle which posed a problem for the LIDAR because it had to be placed to avoid the high spot to allow for maintaining line-of-sight vectors. This caused the bottom edge of the beam to range from 18-60 cm above the ground. This created another complication, as honey bees tend to fly close to the surface.

Using such a conventional LIDAR to track the position honey bees has several drawbacks. The area of investigation needs to be relatively flat in order to maintain a clear line-of-sight with the objects being detected. This limits the ability to track bees or other insects when they fly behind vegetation, hills, posts, and the like. Moreover, LIDAR cannot distinguish between scattered signals from bees and vegetation. The LIDAR beam also needs to be as close to the ground as possible.

Another conventional method for tracking the position of insects in flight is disclosed in “Tracking Butterfly Flight Pass Across The Landscape with Harmonic Radar” by Cantl et al., Proceedings from the Royal Society Biological Sciences (2005) 272 pp. 785-790, incorporated by reference herein. As disclosed therein, harmonic radar is used to track butterfly flight paths. The method involves attaching a transponder to the thorax of a butterfly. A harmonic of the signal is reflected from the transponder attached to the butterfly allowing movement of the butterfly to be distinguished from the radar cluster signal of other objects. However, such a technique also requires a clear line-of-sight to the butterfly and transponder and is limited to medium ranging flights (e.g., hundreds of meters) for a small scale area (e.g., several meters). Using harmonic radar also does not provide high accuracy and visual observation.

### BRIEF SUMMARY OF THE INVENTION

The subject invention, however, in other embodiments, need not achieve all these objectives and the claims hereof should not be limited to structures or methods capable of achieving these objectives.

This invention features a system for determining the position of instrumented biological agents including a plurality of biological agents each having a miniature transmitter/receiver attached thereto. A plurality of antenna is placed about an area of interest. An interrogator subsystem is configured to determine the position of each miniature transmitter/receiver on each of the plurality of biological agents in the area of interest.

In one embodiment, the biological agents are conditioned to detect one or more predetermined substances. The interrogator subsystem may be configured to determine a density of biological agents each having a miniature transmitter/receiver attached thereto to detect the location of a predetermined substance. The miniature transmitter/receiver may include a miniature RF transmitter/receiver. The interrogator subsystem may use triangulation to determine the position of each the transmitter/receiver on each the plurality of biological agents in the area of interest. The interrogator subsystem may be configured to determine the movement of each the transmitter/receiver on each the plurality of biological agents in the area of interest. The plurality of biological agents may include bees. The bees may include honey bees. The bees may include bumble bees. The plurality of biological agents may include moths. The one or more predetermined substances may include a substance which emits a vapor or odor for which the biological agents can be conditioned to detect. The plurality of biological agents may be conditioned to detect explosive chemical compounds. The plurality of biological agents may be conditioned to detect land mines. The plurality of biological agents may be conditioned to detect improvised explosive devices. The plurality of biological agents may be conditioned to detect drugs. The biological agents may include honey bees conditioned to detect land mines. The biological agents may include honey bees conditioned to detect improvised explosive devices. The biological agents may include honey bees conditioned to detect drugs. The system may include a mobile base station for transporting the plurality of biological gents, the plurality of antennae, and the interrogator subsystem to the area of interest. The movement of the biological agents may be used for determining the cause of colony collapse disorder.

This invention further features a system for detecting a substance using instrumented and conditioned biological agents including a plurality of conditioned biological agents each having a miniature transmitter/receiver attached thereto. A plurality of antennae is placed about an area of interest. An interrogator subsystem is configured to determine a density of biological agents each having a miniature transmitter/receiver attached thereto to detect the location of a predetermined substance.

This invention also features a system for detecting movement of one or more instrumented biological agents including one or more biological agents each having a miniature transmitter attached thereto. A plurality of antennae is placed about an area of interest. An interrogator subsystem is configured to determine the movement of each miniature transmitter/receiver on each of the one or more biological agents in the area of interest.

This invention further features a system for detecting a substance using instrumented and conditioned bees including a plurality of bees each having a miniature transmitter/receiver attached thereto. A plurality of antennae is placed about an area of interest. An interrogator subsystem is configured to determine a density of bees each having a miniature transmitter/receiver attached thereto to detect the location of a predetermined substance. In one embodiment, the bees may include honey bees.

This invention also features a method for determining the position of instrumented biological agents including attaching a miniature transmitter/receiver to each of a plurality of biological agents, placing a plurality of antennae about an area of interest, and determining the position of each of the miniature transmitter/receiver on each of the plurality of biological agents in the area of interest.

In one embodiment, the biological agents may be conditioned to detect one or more predetermined substances. The method may include the step of determining the location of a predetermined density of the biological agents each having a miniature transmitter/receiver attached thereto to detect a predetermined substance in the area of interest. The method may include the step of determining the movement of each of the miniature transmitters/receivers on each of the plurality of biological agents in the area of interest. The plurality of biological agents may include bees. The bees may include honey bees. The bees may include bumble bees. The plurality of biological agents may include moths. The one or more predetermined substances may include a substance which emits a vapor or odor the biological agents can be conditioned to detect. The plurality of biological agents may be conditioned to detect explosive chemical compounds. The plurality of biological agents may be conditioned to detect land mines.

The plurality of biological agents may be conditioned to detect improvised explosive devices. The plurality of biological agents may include honey bees conditioned to detect land mines. The plurality of biological agents may include honey bees conditioned to detect improvised explosive devices. The plurality of biological agents may include honey bees conditioned to detect drugs. The method may include the step of transporting the plurality of biological agents each having a miniature transmitter thereon, the plurality of antennae, and an interrogator subsystem to the area of interest. The movement of the plurality of biological agents may be used to determine the cause of colony collapse disorder.

This invention further features a method for determining the movement of instrumented biological agents including attaching a miniature transmitter/receiver to each of a plurality of biological agents, placing a plurality of antennae about an area of interest, and determining the movement of each of the miniature transmitter/receiver on each of the plurality of biological agents in the area of interest.

This invention also features a method for detecting a substance using instrumented and conditioned biological agents including attaching a miniature transmitter/receiver to each of a plurality of conditioned biological agents, placing a plurality of antennae about an area of interest, and determining the location of a predetermined density of the plurality of biological agents each having a miniature transmitter/receiver attached thereto to detect a predetermined substance in the area of interest.

This invention also features a method for detecting a substance using instrumented and conditioned bees including attaching a miniature transmitter/receiver to each of a plurality of bees, placing a plurality of antennae about an area of interest, and determining the location of a predetermined density of the plurality of bees each having a miniature transmitter/receiver attached thereto to detect a predetermined substance in the area of interest.

In one embodiment, the bees may include honey bees.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional side-view of one embodiment of the system for determining the position of instrumented biological agents of this invention;

FIG. 2A is a schematic top view showing one example of the miniature transmitter/receiver shown in FIG. 1 attached to the thorax of a honey bee;

FIG. 2B is a schematic top view showing one example of the miniature transmitter/receiver shown in FIG. 1 attached to the thorax of a bumble bee;

FIG. 2C is a schematic top view showing one example of the miniature transmitter/receiver shown in FIG. 1 attached to the legs of a honey or a bumble bee;

FIG. 2D is a schematic top view showing one example of the miniature transmitter/receiver shown in FIG. 1 attached to one leg of a honey bee;

FIG. 2E is a schematic top view showing one example of the miniature transmitter/receiver shown in FIG. 1 attached to the other leg of a honey bee;

FIG. 2F is a schematic top view showing one example of the miniature transmitter/receiver shown in FIG. 1 attached to the abdomen of a honey bee.

FIG. 3A is a schematic block diagram showing the primary components of one embodiment of a miniature transmitter/receiver which is attached to the biological agents shown in FIGS. 1-2F;

FIG. 3B is a schematic side-view showing in further detail one example of the structure of the miniature transmitter/receiver shown in FIG. 3B;

FIG. 4 is a three-dimensional view showing one example of a three-dimensional Cartesian coordinate system employed with the system shown in FIG. 1;

FIG. 5 is a three-dimensional view showing one example of a three-dimensional cylindrical coordinate system employed with the system shown in FIG. 1;

FIG. 6 is a schematic block diagram showing the one example of the primary processes performed by the signal processing subsystem shown in FIG. 1;

FIG. 7 is a block diagram showing one example of the primary steps associated with attaching a miniature transmitter/receiver to the thorax or abdomen of the biological agents of this invention;

FIG. 8 is a schematic block diagram showing one example of the steps associated transporting the system shown in FIG. 1 to and from a desired location; and

FIG. 9 is a block diagram showing in further detail the steps associated with one embodiment of the method of detecting the position of instrumented biological agents of this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

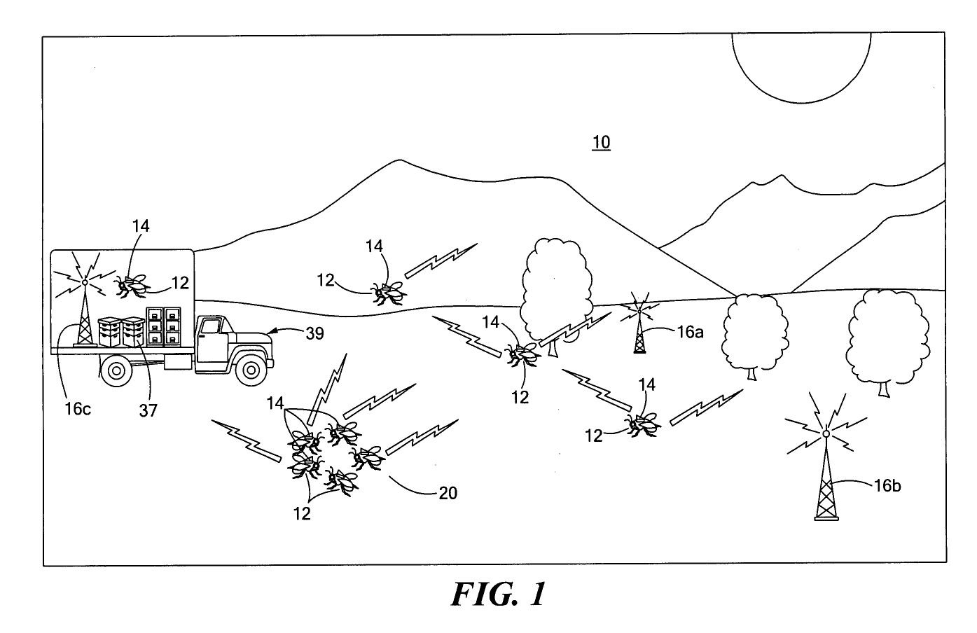

System 10, FIG. 1, for detecting the position of instrumented biological agents of this invention includes a plurality of biological agents 12 each having miniature transmitter/receiver 14 attached thereto. Biological agents 12 may include honey bees, bumble bees, wasps, hornets, moths, cockroaches, beetles, and the like, or any other various insects or biological organism known to those skilled in the art which can fly or move when miniature transmitter/receiver 14 is attached thereto. In one embodiment, biological agents 12 include any insect or biological organism which can be conditioned to detect odors and/or vapors emitted from a target substance. Conditioning of biological agents is known. See, e.g., U.S. Pat. Nos. 6,896,579, 6,919,202, and 7,237,504, cited supra. In one preferred embodiment, biological agents 12 may be honey bees.

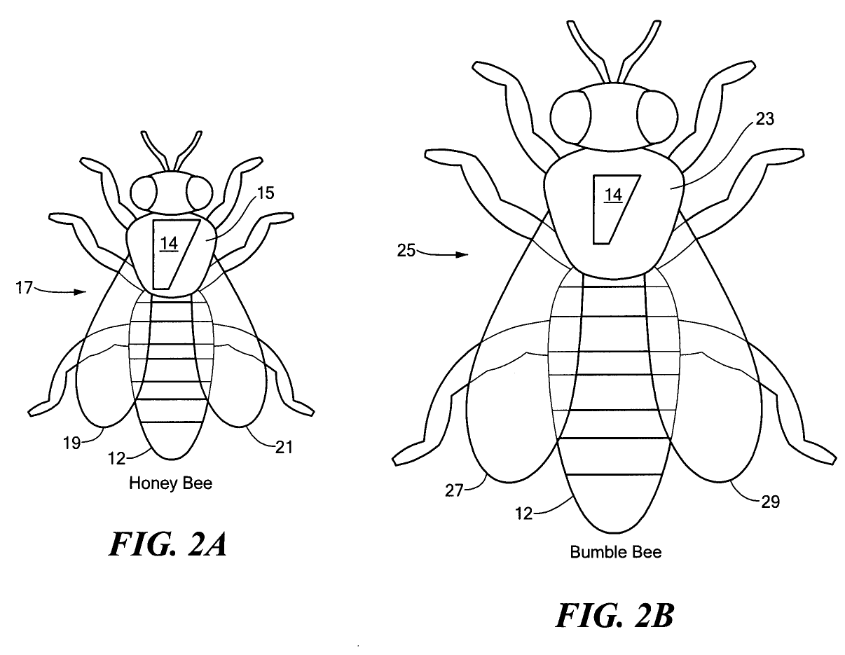

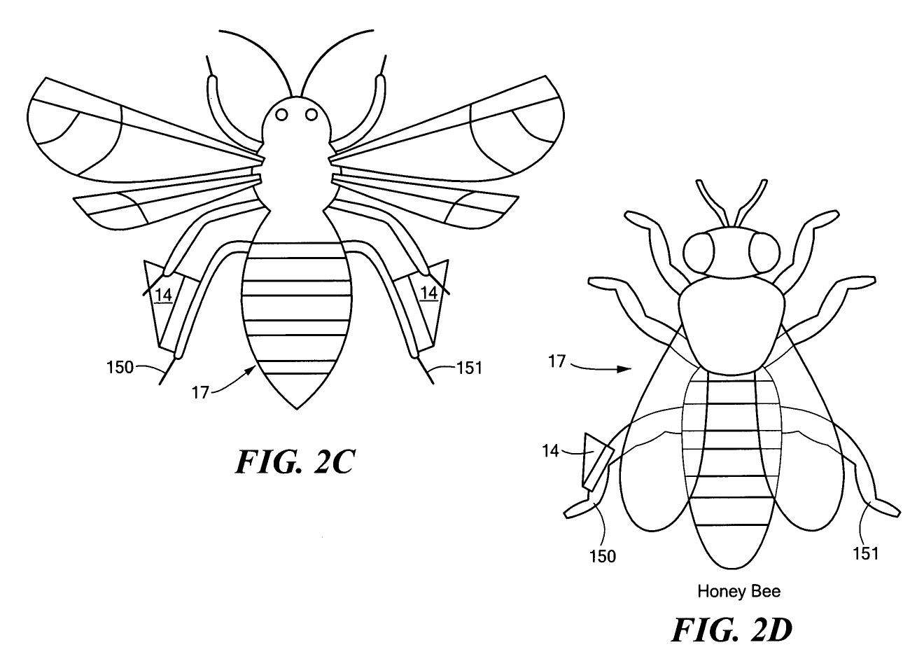

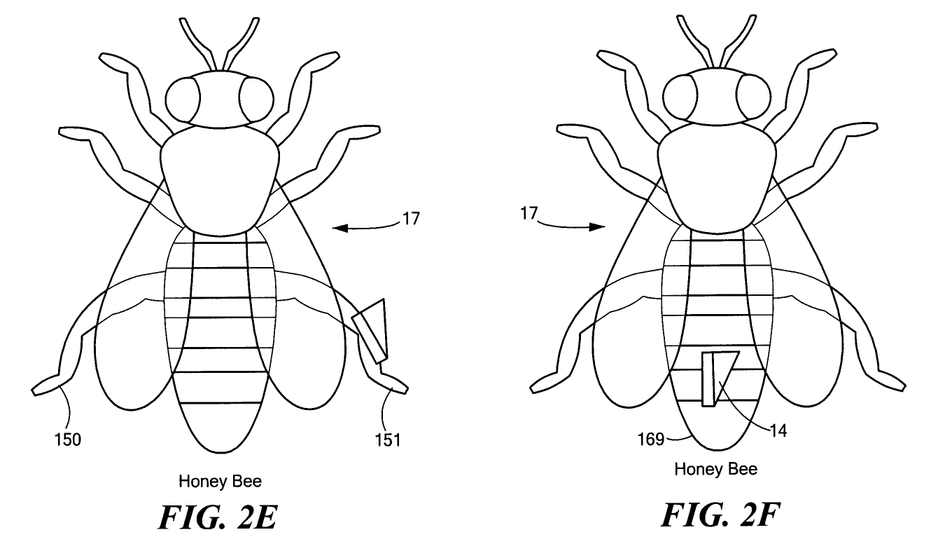

Each miniature transmitter/receiver 14 is typically attached to each of the biological agents 12 using a nontoxic adhesive compound, e.g., a glue, such as fake eyelash glue or any similar type glue which is nontoxic to biological agents 12. In one example, miniature transmitter/receiver 14, FIG. 2A, may be attached to thorax 15 of honey bee 17 positioned between wings 19 and 21. In another example, miniature transmitter/receiver 14, FIG. 2B, may be attached to thorax 23 of bumble bee 25 positioned between wings 27 and 29. Miniature transmitter/receiver 14, FIG. 2C, may also be attached and positioned on legs 150 and 151, e.g., of bee 17. For example, miniature transmitter/receiver 14 may be attached to either of legs 150, 151 or both legs 150, 151, e.g., as shown attached to one leg 150, FIG. 2D, of honey bee 17, attached to another leg 151, FIG. 2E, of honey bee 17, or attached to both legs 150, 151, FIG. 2C, of honey bee 17. Miniature transmitter/receiver 14 may also be mounted on the abdomen a bee, such as a bumble bee or honey bee, e.g., mounted on abdomen 169, FIG. 2F, of honey bee 17. The inventors hereof have found attachment of miniature transmitter/receiver 14 to the abdomen of a bee to be the most effective.

Miniature transmitter/receiver 14 is preferably an ultra-miniature transmitter/receiver having a weight less than about 10 milligrams and a size of about 1.0 mm by 0.5 mm and about by 0.5 mm thick.

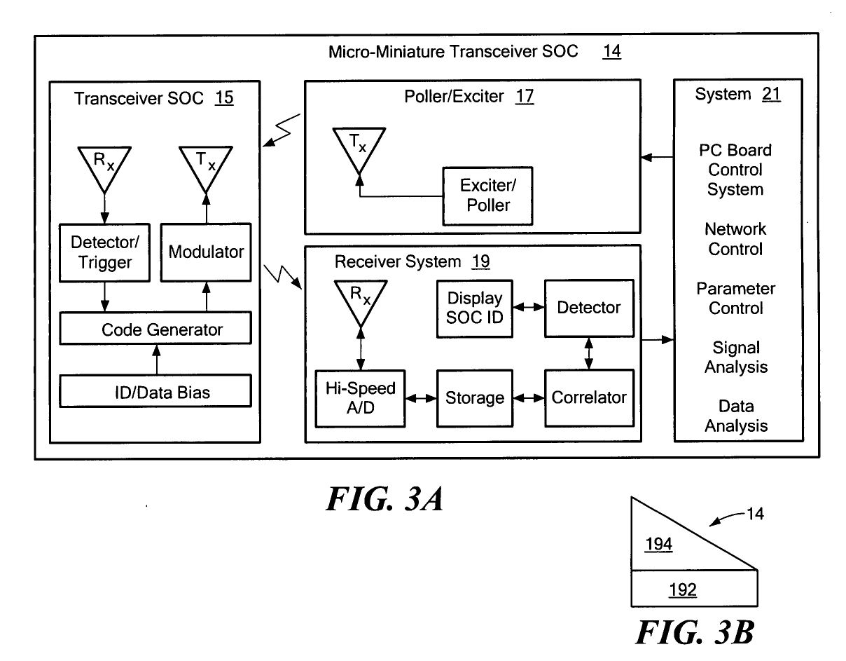

For example, miniature transmitter/receiver 14, FIG. 3A, available from the Mayo Clinic (Rochester, Minn. 55905) is preferably attached to biological agents 12 as discussed with reference to FIGS. 1-2F. Miniature transmitter/receiver 14 typically includes transceiver system-on-a-chip (SOC) 15, poller/exciter 17, receiver system 19, and system components 21. Further details regarding miniature transmitter/receiver 14 are disclosed in U.S. Publication No. 2006/0034348, incorporated by reference herein. In this example, miniature transmitter/receiver 14 is based on a (SOC) design of a radio frequency (RF) transceiver that is combined with micro-miniature antennae. Miniature transmitter/receiver 14 is typically powered by a miniature or microscopic battery, e.g., disclosed in U.S. Pat. Nos. 6,610,440, 7,144,654, and 7,166,384, all of which are incorporated by reference herein. Another example of a miniature battery which may be used to power miniature transmitter/receiver 14 is available from Widetronix Semiconductors (Ithaca, N.Y. 14850). FIG. 3B shows one example of miniature transmitter/receiver 14 comprised of chip 192, e.g. a die such as an ASIC, integrated circuit, and the like, and antenna 194.

System 10, FIG. 1, also includes interrogator subsystem 18 and a plurality of antennae, e.g., antennae 16a, 16b, 16c placed about an area of interest. Interrogator subsystem 18 is preferably a computer subsystem, e.g., a personal computer or similar type computer subsystem, which includes, inter alia, at least one interrogator, hardware and software, digital processing hardware and software, storage, memory, one or monitors, and the like, as known by those skilled in the art.

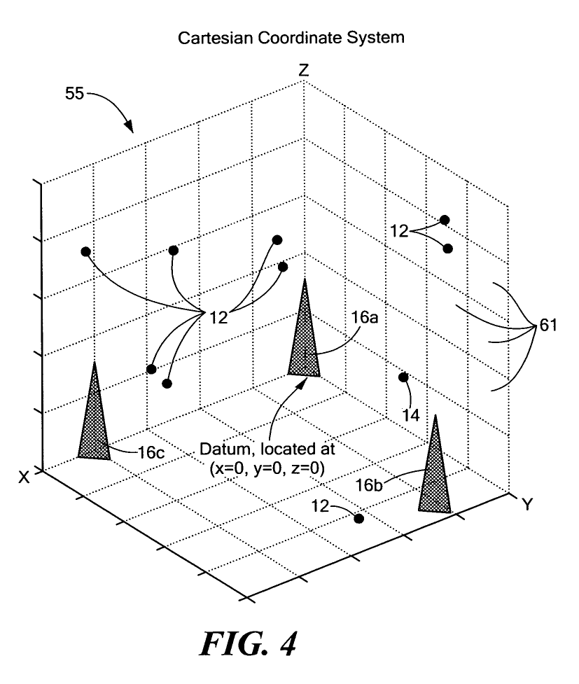

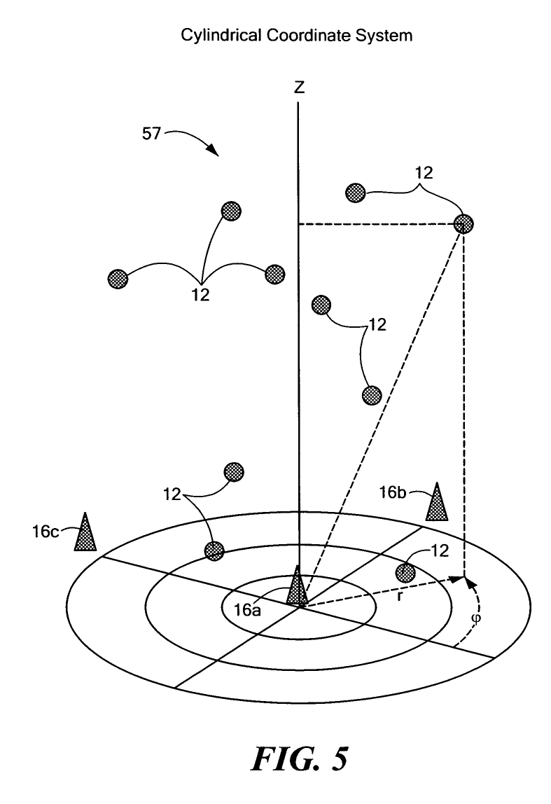

In operation, interrogator subsystem 18 transmits signals to each of the plurality of antennae 16a, 16b and 16c. Each of the plurality of antennae 16a, 16b and 16c then broadcasts return signals to interrogator subsystem 18. Based on the amount of time the signals take to go from interrogator subsystem 18 to each of the plurality of antennae 16a, 16b, and 16c and back to the interrogator subsystem 18, the distance to each of the plurality of antennae 16a, 16b and 16c and interrogator subsystem 18 is determined. These distances are then used to establish a physical datum, typically at one of antennae 16a, 16b and 16c. FIG. 4, where like parts are given like numbers, shows one example of a physical datum established at antenna 16a. In this example, a Cartesian coordinate system is used. Therefore, the physical datum at antenna 16a will have the coordinates x=0, y=0, and z=0, where x, y, and z are measured in Km or m. In one example, the physical datum at antenna 16b may have the coordinates x=0, y=0.5, and z=0, and the physical datum at antenna 16c may have the coordinates x=0.5, y=0, and z=0, where x, y, and z are similarly measured in Km or m. In another embodiment, a cylindrical coordinate system may be utilized. When the cylindrical coordinate system is used, the physical datum established at antenna 16a, FIG. 5, where like parts have been given like numbers, will have the coordinates r=0, Φ=0, z=0, where r and z are measured in Km or m, and Φ is measured in degrees. In one example, the physical datum at antenna 16b may have the coordinates r=0.5, Φ=90, z=0, and the physical datum at antenna 16b may have the coordinates r=0.5, Φ=180, z=0, where r and z are measured in Km or m, and Φ is measured in degrees. The physical datum is a reference point from which all distances are derived.

Once the physical datum is established, interrogator subsystem 18, FIG. 1, generates a three dimensional coordinate system, e.g., three-dimensional coordinate system 55, FIG. 4, or three-dimensional coordinate system 57, FIG. 5, corresponding to the area of interest. The three-dimensional coordinate system may be divided into finite regions of volume, e.g., the finite regions of volume shown in three-dimensional volume 61, FIG. 4. Once the physical datum and the three-dimensional coordinate system are established, the interrogator subsystem 18, FIG. 1, transmits signals to each of the plurality of antennae 16a, 16b and 16c at a predetermined repetition rate, e.g., 1 signal per second. Each of the plurality of antennae 16a, 16b and 16c then broadcasts signals to interrogate each miniature transmitter/receiver 14 on each of the plurality of biological agents 12. In response to these interrogator signals, each miniature transmitter/receiver 14 on each of the biological agents 12 sends a response signal back to each of plurality of antennae 16a, 16b and 16c. The signals from each of plurality of antennae 16a, 16b and 16c are then sent back to interrogator subsystem 18. Interrogator subsystem 18 then measures the amount of time it takes to send and receive signals from each of the plurality of antennae 16a, 16b, 16c and to each miniature transmitter/receiver 14 on each biological agent 12. Interrogator subsystem 18 then uses triangulation methods to determine the position and/or movement of each miniature transmitter/receiver 14 on each of the plurality of biological agents 12 in the three dimensional coordinate system.

The result is the position and/or movement of each miniature transmitter/receiver 14 on biological agents 12 is determined. Because system 10 utilizes miniature transmitter/receivers that are attached to biological agents, system 10 does not require a line-of-sight to the biological agents each with transmitter/receiver thereon. Thus, system 10 operates effectively regardless of the type of terrain and can distinguish between the biological agents being tracked and the terrain. System 10 also can operate efficiently at distance up of at least 1 Km. Because system 10 can track the movement of biological agents, each with a transmitter/receiver thereon, the taxis, or movement of biological agents 12 either toward or away from a stimulus can be determined. Exemplary taxis include, inter alia, anemotaxis (oriented movement in response to a current of air), phototaxis (light), thermotaxis (heat), chemotaxis (chemicals), geotaxis (gravity), heleotaxis, (sunlight), hydrotaxis (water), magnetotaxis (magnetic field), and the like. The taxis can then be interpreted to determine the behavior of the biological agents, e.g., feeding behavior, migration behavior, attack behavior, and the like. Knowing the taxis and/or behavior of biological agents, such as bees, may help biologists and scientists to determine cause of, inter alia, colony collapse disorder.

Interrogator subsystem 18 can also be configured to calculate a density of biological agents 12 each having miniature transmitter/receiver 14 thereon to detect the location of target substance. To do this, the density of miniature transmitter/receivers 14 in a finite area of volume is calculated, e.g., the number of miniature transmitter/receivers 14, FIG. 4, in each finite volume of three-dimensional volume 61. Interrogator subsystem 18 then counts the number of miniature transmitter/receivers 14 in each region of volume 61 and divides by the volume of the region. This results in quantitative values as to the number of miniature transmitter/receiver 14 per cubic meter. This density is then compared to a minimum threshold density value, e.g., 5 miniature transmitters/receivers 14 per cubic meter. Regions where the density of miniature transmitter/receivers 14 exceeds the minimum threshold are identified and displayed on the coordinate system and on a monitor (not shown) connected to interrogator subsystem 18, FIG. 1, e.g., swam 20. Although in this example the minimum threshold density was about five biological agents each with a miniature transmitter/receiver 14 thereon, the minimum threshold density may vary as known by those skilled in the art. The density of biological agents 12 and miniature transmitter/receivers 14 provides an indication as to the location of the target substance in the area of interest. In one example, the target substance which may be detected by instrumented and conditioned biological agents 12 of system 10 may include an improvised explosive device (IED), a landmine, drugs, or virtually any inorganic or organic substance, chemicals, chemical compounds, explosive chemical compounds, bacteria, and viruses, and the like, that may be suspended in air, vaporized, emit an odor and the like, that biological agents 12 may be conditioned to detect. Then, the appropriate personnel, e.g., a bomb squad or hazardous waste removal team, can be deployed to the area where the target substance has been detected.

The result is system 10 utilizes instrumented and conditioned biological agents to effectively detect virtually any a target substance that emit vapors and/or odors for which the biological agents have been conditioned to detect. Because system 10 may utilize mobile base station 39, system 10 can be quickly deployed to an area of interest that includes the target substance to be detected.

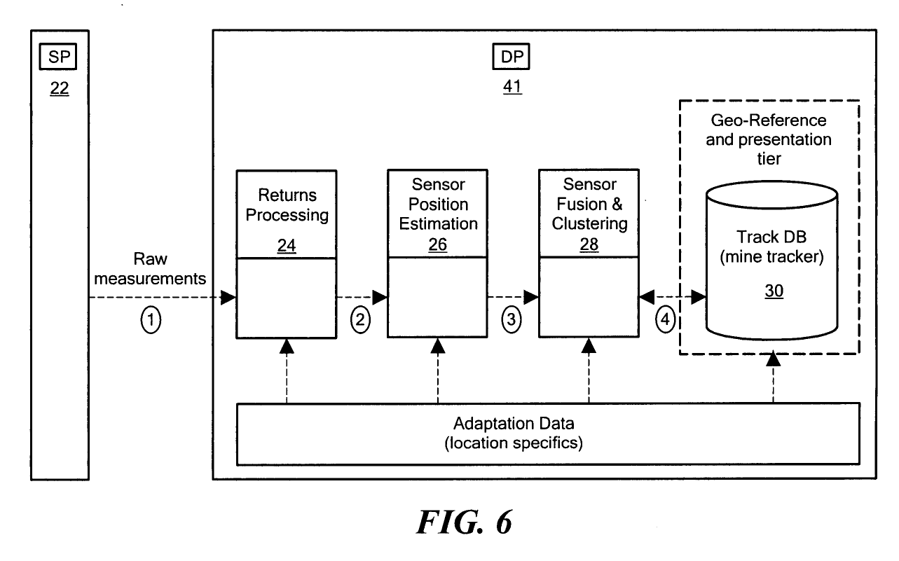

FIG. 6 is a schematic block diagram of one example of the processing performed by the signal and data processing hardware and software of interrogator subsystem 18, FIG. 1. In this example, signal processing module 22, FIG. 6, receives the raw individual data from each miniature transmitter/receiver 14 attached to each of the plurality of biological agents 12 received via the plurality of antennae 16a, 16b, 16c and transmitted to interrogator subsystem 18. Digital processing module 41 receives the raw measurements from signal processing 22, as shown at 35. Returns processing module 24 modifies raw measurements into a returns report for digital signal processing. Returns processing module 24 applies site adjustable parameters (SAP) corrections and normalizations. The output from returns processing 24 is typically a formatted report for each miniature transmitter/receiver 14 with an adjusted SAP location and report generated for downstream processing. Sensor position estimation module 26 receives data from returns processing 24 and generates a single position estimate (resolve) based on the n-measurement, where n is the number of transmit antenna. Sensor fusion and clustering module 28 receives data from sensor position estimation 26 and cluster/fuses individual measurements from each miniature transmitter/receiver 14 to generate a mine-cluster track file 30 which is read from a cluster database to calculate miniature transmitter/receiver 14 geographic density and then assign probability to the cluster track file.

In one design, system 10, FIG. 1, includes mobile base station 39, e.g., a motor vehicle, which stores biological agent housing 37, e.g., bee hives or any suitable housing for any type of biological agents that may be utilized. Mobile base station 39 also houses interrogator subsystem 18 and the plurality of antennae 16a, 16b, 16c before they are deployed. Mobile base station 39 allows system 10 to be deployed to an area of interest to determine the position and/or movement of biological agents 12 and/or to detect a target substance. Once at the desired location, the plurality of antennae 16a, 16b, 16c are setup about the area of interest. Then, the plurality of biological agents 12 each having a miniature transmitter/receiver 14 thereon are released from housing 37. Interrogator subsystem 18 is then made operational and the position and/or movement of biological agents 12 is determined, and/or the target substance detected, as discussed above.

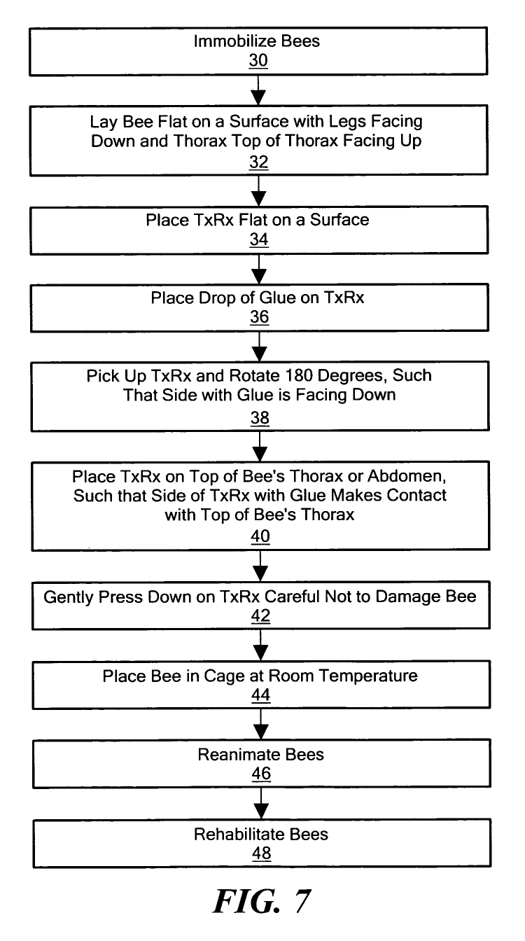

One example of the method for attaching each miniature transmitter/receiver 14 to the thorax or abdomen of each of the plurality of biological agents 12 is described below with reference to FIG. 7. In this example, the plurality of biological agents 12 are preferably honey bees, although any suitable biological agents which can fly or move when miniature transmitter/receiver 14 is attached thereto and/or which may be conditioned to detect a target substance may be utilized. The biological agents are immobilized, step 30, FIG. 7, e.g., with an ice bath. A biological agent 12 is then laid on a flat surface with its legs facing down and thorax facing up, step 32. Miniature transmitter/receiver 14 is then placed on a flat surface, step 34. A small drop of glue, e.g., fake eyelash glue, is placed on miniature transmitter/receiver 14, step 36. Miniature transmitter/receiver 14 is picked up and rotated 180° such that the side with the glue is facing down, step 38. Miniature transmitter/receiver 14 is placed on top of the thorax, as shown in FIGS. 2A-2B, or the abdomen, as shown in FIG. 2F of biological agent 12 such that the side of miniature transmitter/receiver 14 with the glue makes contact with the top of the thorax or abdomen of biological agent 12, step 40. Miniature transmitter/receiver 14 is gently pressed down on the biological agent 12, step 42. Biological agents 12 are then placed in a cage at room temperature, step 44. Steps 32 through 44 are repeated for each of the plurality of biological agents 12. Biological agents 12 are then re-animated, step 46 and rehabilitated, step 48. A similar process is performed to attach miniature transmitter/receiver 14 to the legs of biological agents 12.

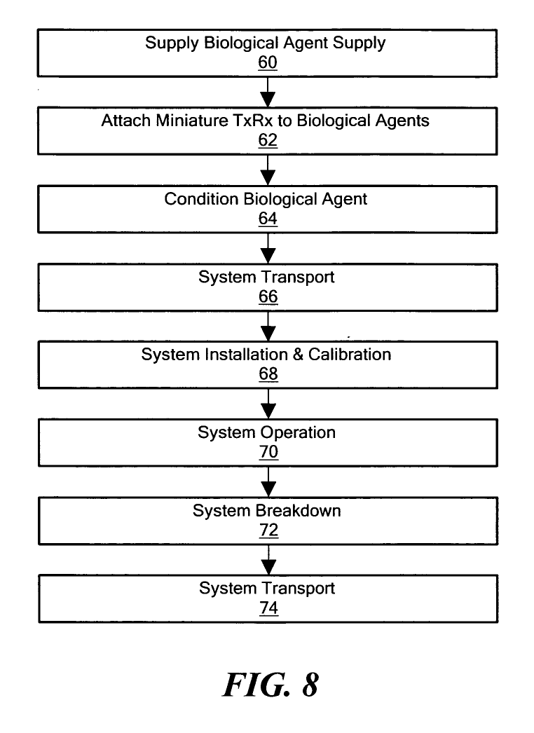

FIG. 8 is flow chart depicting one example of the primary steps associated with one embodiment of the method for determining the position and/or the movement of biological agents 12 and/or detecting the location of a target substance using biological agents 12 in accordance with this invention. In this example, supply of biological agents 12, e.g., bees, is provided, step 60. A miniature transmitter/receiver 14 is then attached to each of biological agents 12, step 62. The biological agents 12 may then be conditioned, step 64, and transported to the predetermined area, step 66. System 10, FIG. 1, is installed and calibrated, as discussed above, step 68, FIG. 8. System 10 then determines the position and/or movement of biological agents 12 and/or determines the location of the target substance in the area of interest, step 70. Once complete, system 10 is broken down, step 72, and transported to a secure area, step 74.

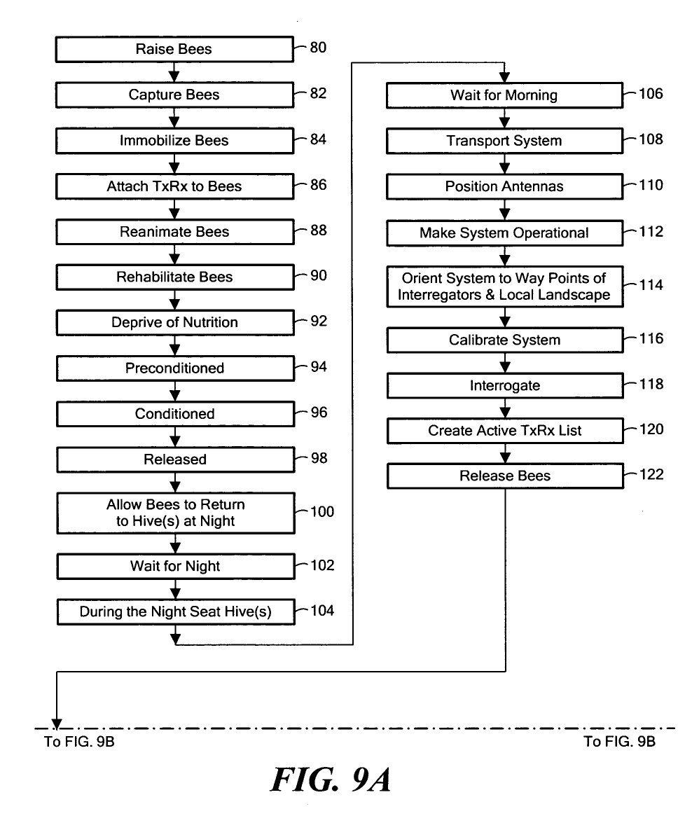

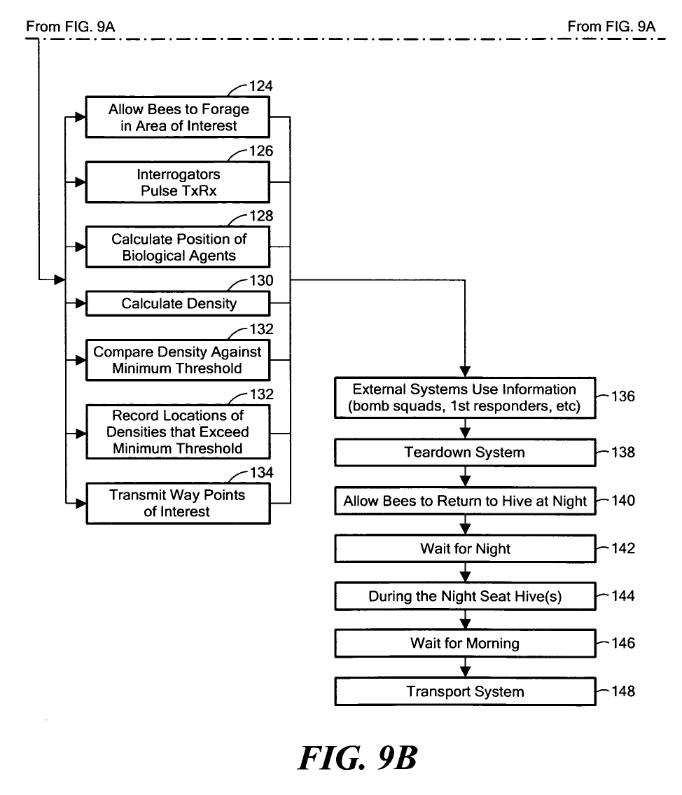

FIG. 9 is a flow chart showing further detail one example of the steps associated with one embodiment of the method for detecting location of a target substance using instrumented and conditioned biological agents of this invention. The method is described below with reference to FIG. 9. In this example, the plurality of biological agents 12 are preferably bumble or honey bees, although any other suitable biological agents may be utilized, as discussed above. Biological agents 12 are raised, step 80. The biological agents 12 are then captured, step 82, and immobilized at step 84. A miniature transmitter/receiver 14 is attached to each of the plurality of biological agents 12, step 86, as discussed above. The biological agents 12 are then re-animated, step 88, and rehabilitated, step 90. The biological agents 12 are then deprived of nourishment, step 92. The biological agents 12 are pre-conditioned, step 94. The biological agents 12 are then conditioned, step 96. Thereafter, the biological agents 12 are released, step 98. The biological agents 12 are allowed to return to the hive at night, step 100. The method then waits for nighttime, step 102. During the night the hives are sealed, step 104. The method then waits for the morning, step 106. System 10 is transported using mobile base station 39 to a predetermined area, step 108. The plurality of antennae 16a, 16b, 16c are located about the predetermined area, step 110. System 10 is then made operational, step 112. System 10 is then calibrated orientated to the way points of the plurality of antennae 16a, 16b, 16c and the local landscape, step 114. System 10 is calibrated, step 116. Each miniature transmitter/receiver 14 on each of biological agents 12 is interrogated, step 118. Interrogator subsystem 18 then generates a list of transmitters/receivers 14 on each of the plurality of biological agents 12, step 120. The biological agents 12 are then released into the area of interest, step 122. The biological agents 12 are allowed to forage in the interest, step 124. An interrogator pulse is then sent by interrogator subsystem 18 to each transmitter/receiver 14 on each of the plurality of biological agents 12, step 126. The position of the biological agents 12 is then calculated, step 128. A calculation of the density of biological agents 12 is then performed, step 130. The calculated density of biological agents 12 is then compared against a minimum threshold density, step 132. The position of the density of biological agents 12 that exceeds the minimum threshold is then recorded, step 132. Interrogator subsystem 18 then transmits the way points of interest that determines the location of the target substance in the predetermined area, step 134. External systems, e.g., bomb squads or first responders and the like, may use the information obtained as to the location of the target substance, step 136. The system is then torn down, step 138. The biological agents 12 are then returned to the hive at night, step 140. The method then waits the night, step 142. During the night, the hives are sealed, step 144. The method then waits for morning, step 146. Finally, the system is transported to a secure location, step 148.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

1. A system for determining the position of instrumented biological agents comprising:
a plurality of biological agents each having a miniature transmitter/receiver attached thereto;
a plurality of antenna placed about an area of interest; and
an interrogator subsystem configured to determine the position of each miniature transmitter/receiver on each of the plurality of biological agents in the area of interest.

2. The system of claim 1 in which the biological agents are conditioned to detect one or more predetermined substances.

3. The system of claim 2 in which the interrogator subsystem is configured to determine a density of biological agents each having a miniature transmitter/receiver attached thereto to detect the location of a predetermined substance.

4. The system of claim 1 in which the miniature transmitter/receiver includes a miniature RF transmitter/receiver.

5. The system of claim 1 in which the interrogator subsystem uses triangulation to determine the position of each said transmitter/receiver on each said plurality of biological agents in the area of interest.

6. The system of claim 5 in which the interrogator subsystem is configured to determine the movement of each said transmitter/receiver on each said plurality of biological agents in the area of interest.

7. The system of claim 1 in which the plurality of biological agents include bees.

8. The system of claim 7 in which said bees include honey bees.

9. The system of claim 7 in which said bees include bumble bees.

10. The system of claim 1 in which the plurality of biological agents include moths.

11. The system of claim 2 in which the one or more predetermined substances include a substance which emits a vapor or odor for which the biological agents can be conditioned to detect.

12. The system of claim 3 in which the plurality of biological agents are conditioned to detect explosive chemical compounds.

13. The system of claim 3 in which the plurality of biological agents are conditioned to detect land mines.

14. The system of claim 3 in which the plurality of biological agents are conditioned to detect improvised explosive devices.

15. The system of claim 3 in which the plurality of biological agents are conditioned to detect drugs.

16. The system of claim 3 in which the biological agents include honey bees conditioned to detect land mines.

17. The system of claim 3 in which the biological agents include honey bees conditioned to detect improvised explosive devices.

18. The system of claim 3 in which the biological agents include honey bees conditioned to detect drugs.

19. The system of claim 1 further including a mobile base station for transporting the plurality of biological gents, the plurality of antennae, and the interrogator subsystem to the area of interest.

20. The system of claim 6 in which said movement of said biological agents is used for determining the cause of colony collapse disorder.

21. A system for detecting a substance using instrumented and conditioned biological agents comprising:
a plurality of conditioned biological agents each having a miniature transmitter/receiver attached thereto;
a plurality of antennae placed about an area of interest; and
an interrogator subsystem configured to determine a density of biological agents each having a miniature transmitter/receiver attached thereto to detect the location of a predetermined substance.

22. A system for detecting movement of one or more instrumented biological agents comprising:
one or more biological agents each having a miniature transmitter attached thereto;
a plurality of antennae placed about an area of interest; and
an interrogator subsystem configured to determine the movement of each miniature transmitter/receiver on each of the one or more biological agents in the area of interest.

23. A system for detecting a substance using instrumented and conditioned bees comprising:
a plurality of bees each having a miniature transmitter/receiver attached thereto;
a plurality of antennae placed about an area of interest; and
an interrogator subsystem configured to determine a density of bees each having a miniature transmitter/receiver attached thereto to detect the location of a predetermined substance.

24. The system of claim 23 in which said bees include honey bees.

25. A method for determining the position of instrumented biological agents comprising:
attaching a miniature transmitter/receiver to each of a plurality of biological agents;
placing a plurality of antennae about an area of interest; and
determining the position of each of the miniature transmitter/receiver on each of the plurality of biological agents in the area of interest.

26. The method of claim 25 in which the biological agents are conditioned to detect one or more predetermined substances.

27. The method of claim 26 further including the step of determining the location of a predetermined density of said biological agents each having a miniature transmitter/receiver attached thereto to detect a predetermined substance in the area of interest.

28. The method of claim 25 further including the step of determining the movement of each of the miniature transmitters/receivers on each of the plurality of biological agents in the area of interest.

29. The method of claim 26 in which the plurality of biological agents includes bees.

30. The method of claim 29 in which said bees include honey bees.

31. The method of claim 29 in which said bees include bumble bees.

32. The method of claim 26 in which the plurality of biological agents include moths.

33. The method of claim 25 in which the one or more predetermined substances include a substance which emits a vapor or odor said biological agents can be conditioned to detect.

34. The method of claim 27 in which the plurality of biological agents are conditioned to detect explosive chemical compounds.

35. The method of claim 27 in which the plurality of biological agents are conditioned to detect land mines.

36. The method of claim 27 in which the plurality of biological agents are conditioned to detect improvised explosive devices.

37. The method of claim 27 in which the plurality of biological agents include honey bees conditioned to detect land mines.

38. The method of claim 27 in which the plurality of biological agents include honey bees conditioned to detect improvised explosive devices.

39. The method of claim 27 in which the plurality of biological agents include honey bees conditioned to detect drugs.

40. The method of claim 25 further including the step of transporting the plurality of biological agents each having a miniature transmitter thereon, the plurality of antennae, and an interrogator subsystem to the area of interest.

41. The method of claim 28 in which said movement of said plurality of biological agents is used to determine the cause of colony collapse disorder.

42. A method for determining the movement of instrumented biological agents comprising:
attaching a miniature transmitter/receiver to each of a plurality of biological agents;
placing a plurality of antennae about an area of interest; and
determining the movement of each of the miniature transmitter/receiver on each of the plurality of biological agents in the area of interest.

43. A method for detecting a substance using instrumented and conditioned biological agents comprising:
attaching a miniature transmitter/receiver to each of a plurality of conditioned biological agents;
placing a plurality of antennae about an area of interest; and
determining the location of a predetermined density of said plurality of biological agents each having a miniature transmitter/receiver attached thereto to detect a predetermined substance in the area of interest.

44. A method for detecting a substance using instrumented and conditioned bees comprising:
attaching a miniature transmitter/receiver to each of a plurality of bees;
placing a plurality of antennae about an area of interest; and
determining the location of a predetermined density of said plurality of bees each having a miniature transmitter/receiver attached thereto to detect a predetermined substance in the area of interest.

45. The method of claim 44 in which said bees include honey bees.
